(19) United States
(12) Patent Application Publication
(10) Pub. No.: US 2007/0294326 A1
(43) Pub. Date: Dec. 20, 2007

(54) Hybrid Computer

(76) Inventor: Nuri Saryal, Ankara (TR)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 10/590,594

(22) PCT Filed: Feb. 27, 2004
(86) PCT No.: PCT/TR04/00013

§ 371 Date: May 3, 2007

(51) Int. Cl. G06J 1/00

(52) U.S. Cl. 708/6

(57) ABSTRACT

In the hybrid computer of the invention, cells including analog integrator circuits (1, 2) and micro controllers connect with each other through coordinator cells and they operate synchronously and make time continuous integration. By means of micro controllers, results of the integration process are transferred to the digital computer having data acquisition system where they are processed. After processing, results are displayed on the digital computer (7).

### FIELD OF THE INVENTION

This invention is related to hybrid computers.

### BACKGROUND OF THE INVENTION

Because of the recent development and advance in microelectronics it is possible to build very powerful digital computers. But digital computers, besides that they cannot achieve exact solution to some problems, have also some other disadvantages.

One of the disadvantages of digital computation is the necessity of converting differential equations into “finite difference” form, because it is not possible to integrate time continuously by using digital circuits. For example, during the solution of the Navier-Stokes equations, that are used to solve unsteady state compressible fluid flow problems, the integration of partial differential equations by using digital computers can easily cause instability errors and convergence problems.

Further more, when it is required to solve a great number of differential equations simultaneously, the fact that they cannot run parallel efficiently is another problem of the digital computers. “It could take 100 years for the largest existing system to perform a complete protein-folding computation” Thomas Sterling—NASA Jet Propulsion Laboratory High Performance Computation Group.

Among the problems, today's computers have to overcome are their high cost and excessive power consumption. These and reasons mentioned above, provoke the consideration of analog circuits as integrators. But, the results obtained from analog circuits performing integration include considerable error, due to the “voltage drift” of operational amplifiers (Opamp). It is assumed that with ideal Opamps used as followers, the output is exactly equal to the input. But due to the fact that opamps used in actual life are not ideal and are influenced by changing temperatures and similar reasons, there is a difference between the input and output voltages and this difference is reflected to the integrations causing the mentioned error. In the previous technology, to cancel this offset several methods have been tried but they are complicated and insufficient. The most important one is the chopper-stabilization. (Schwarz, Helmut “Elektrische Analogrechner”). But even with this method the necessary sensitivity cannot be reached. Considering that especially during integration of small differences great errors occur, the importance of canceling the drift voltage error will be better understood.

### OBJECT OF THE INVENTION

Object of the invention is to develop a hybrid computer with analog integrator circuits, having the ability to integrate time continuously and fast.

### DETAILED DESCRIPTION OF THE INVENTION

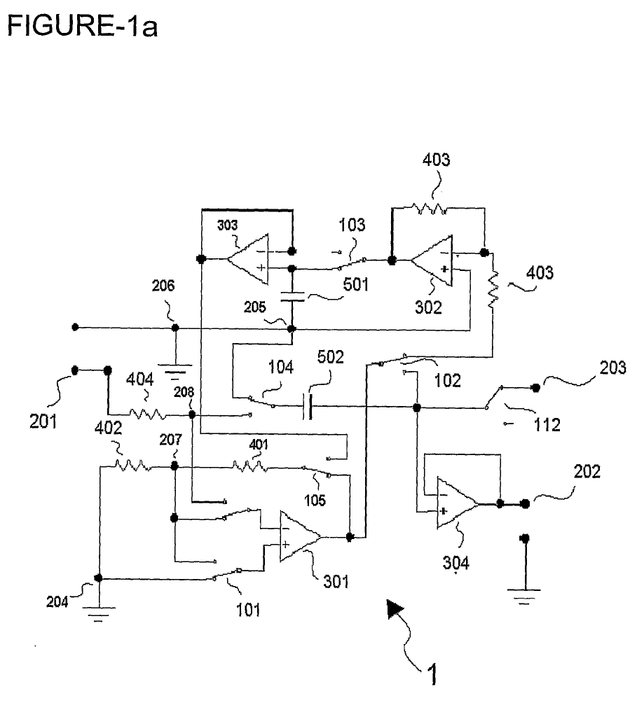

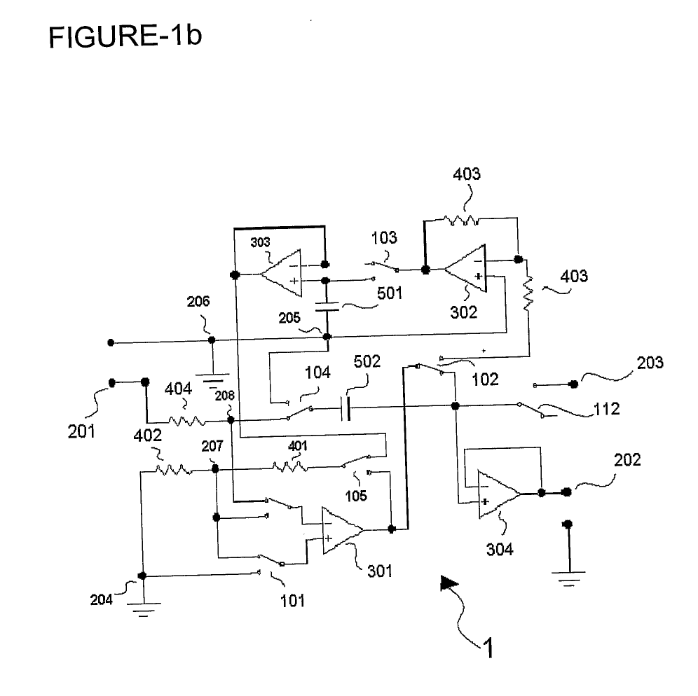

FIG. 1a—Negative Integrator Circuit with Analog Memory in Reset Mode.

FIG. 1b—Negative Integrator Circuit with Analog Memory in Run Mode.

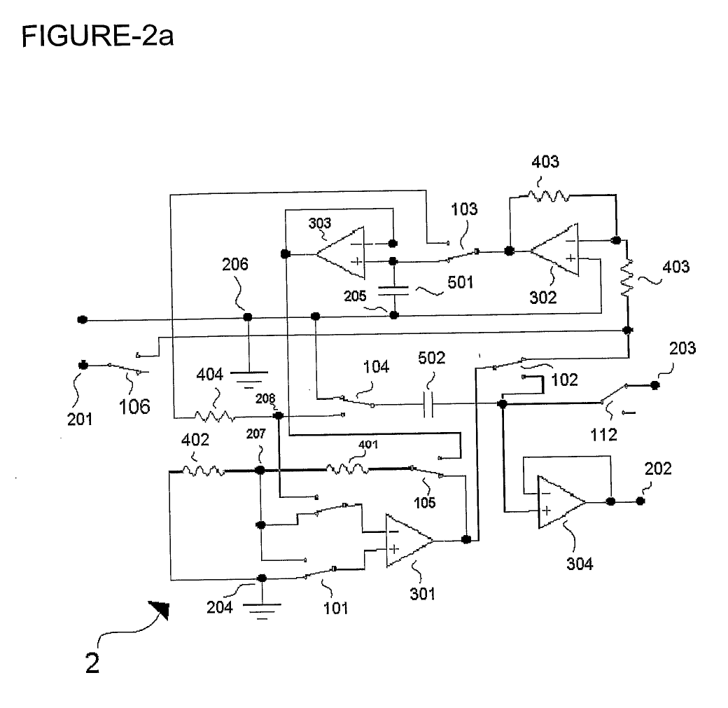

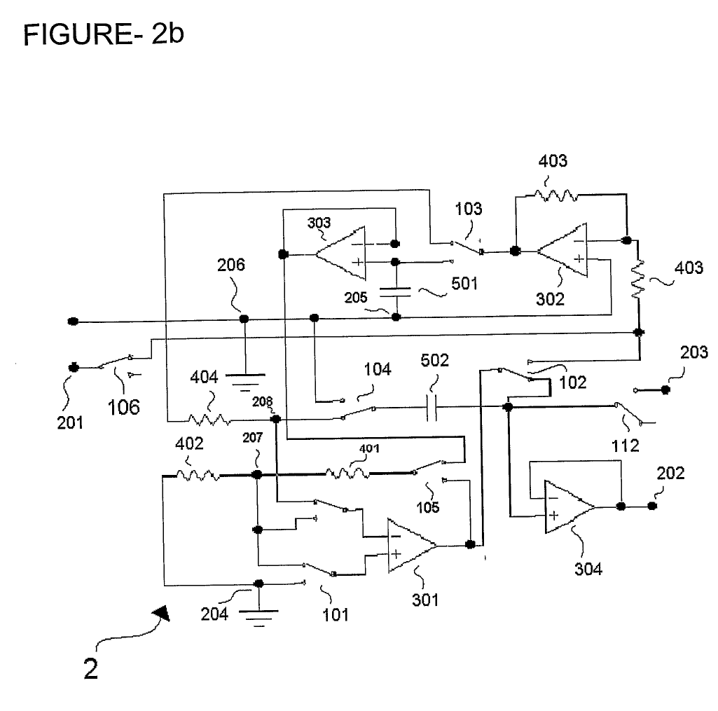

FIG. 2a—Positive Integrator Circuit with Analog Memory in Reset Mode.

FIG. 2b—Positive Integrator Circuit with Analog Memory in Run Mode.

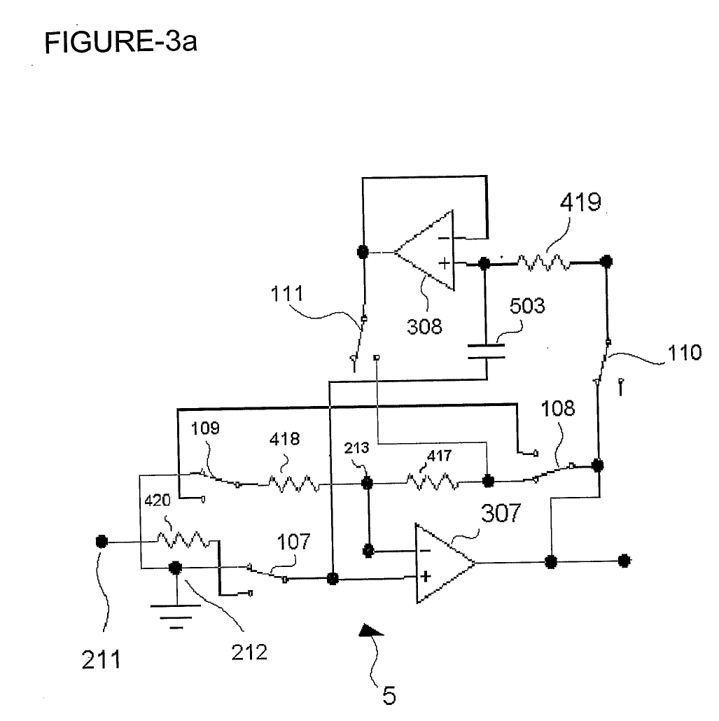

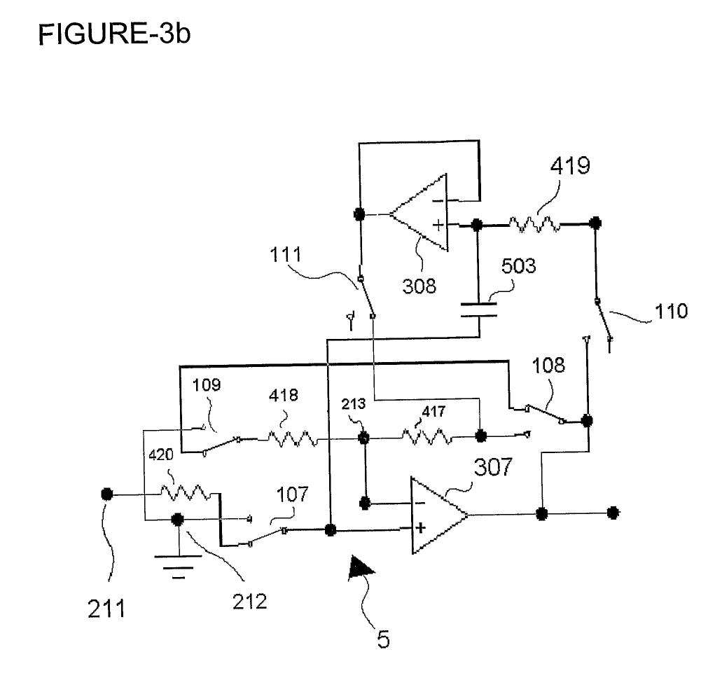

FIG. 3a—Follower Circuit in Reset Mode.

FIG. 3b—Follower Circuit in Run Mode.

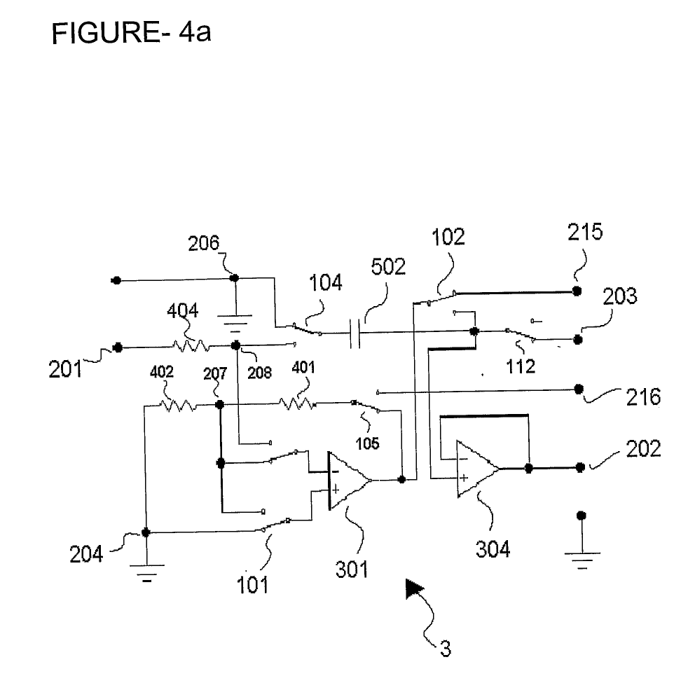

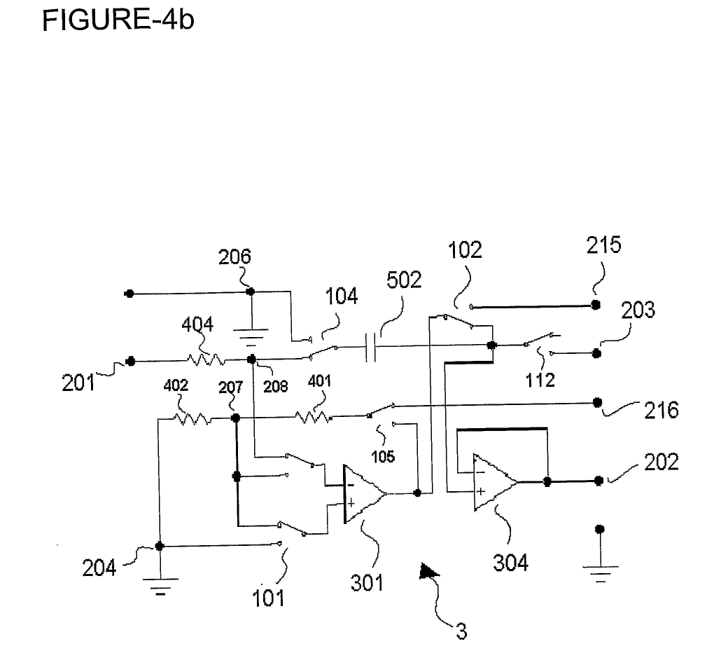

FIG. 4a—Negative Integrator Circuit with Digital Memory in Reset Mode.

FIG. 4b—Negative Integrator Circuit with Digital Memory in Run Mode.

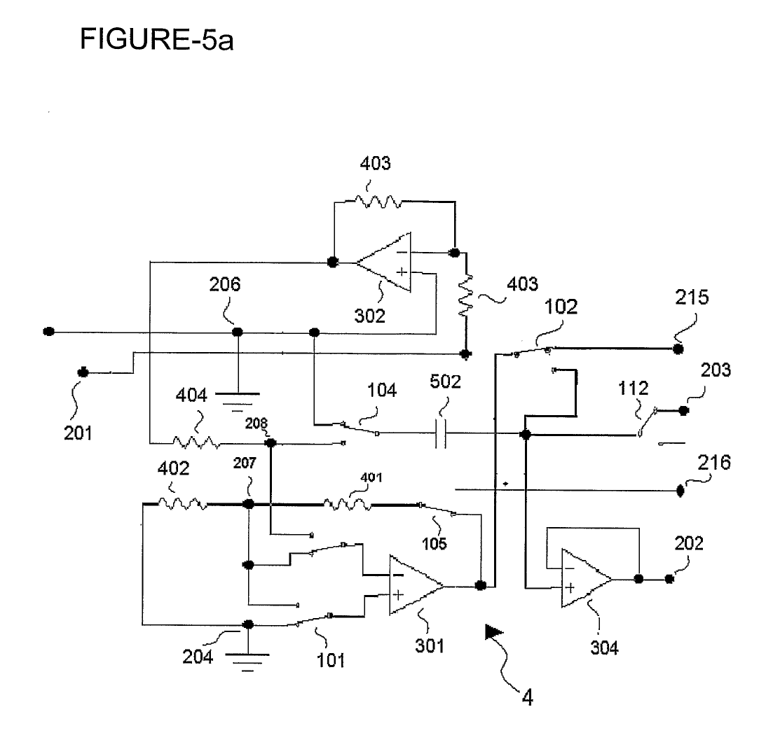

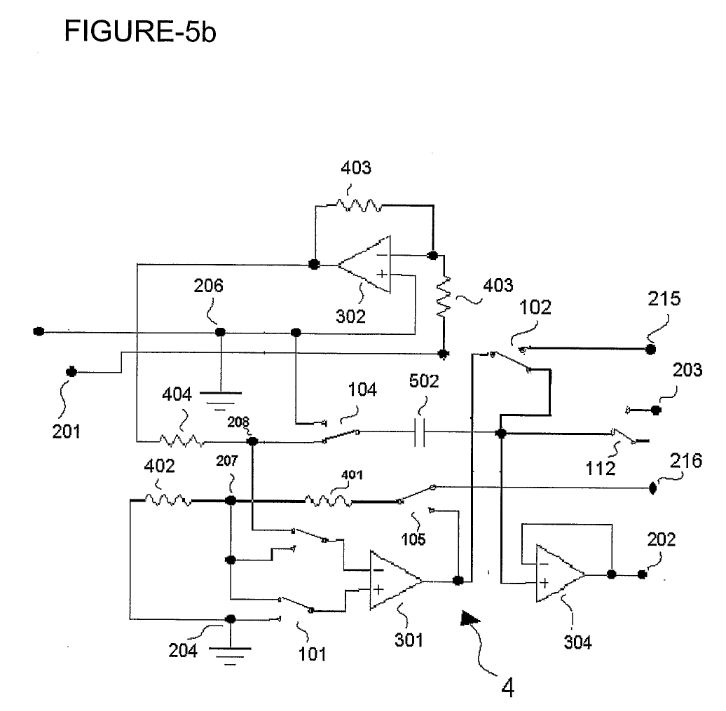

FIG. 5a—Positive Integrator Circuit with Digital Memory in Reset Mode.

FIG. 2b—Positive Integrator Circuit with Digital Memory in Run Mode.

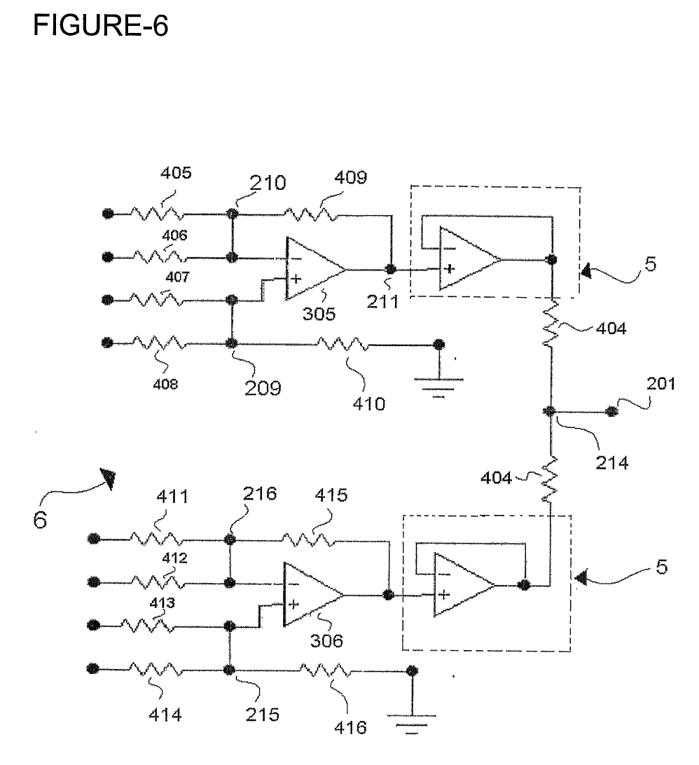

FIG. 6—Coordinator Circuit.

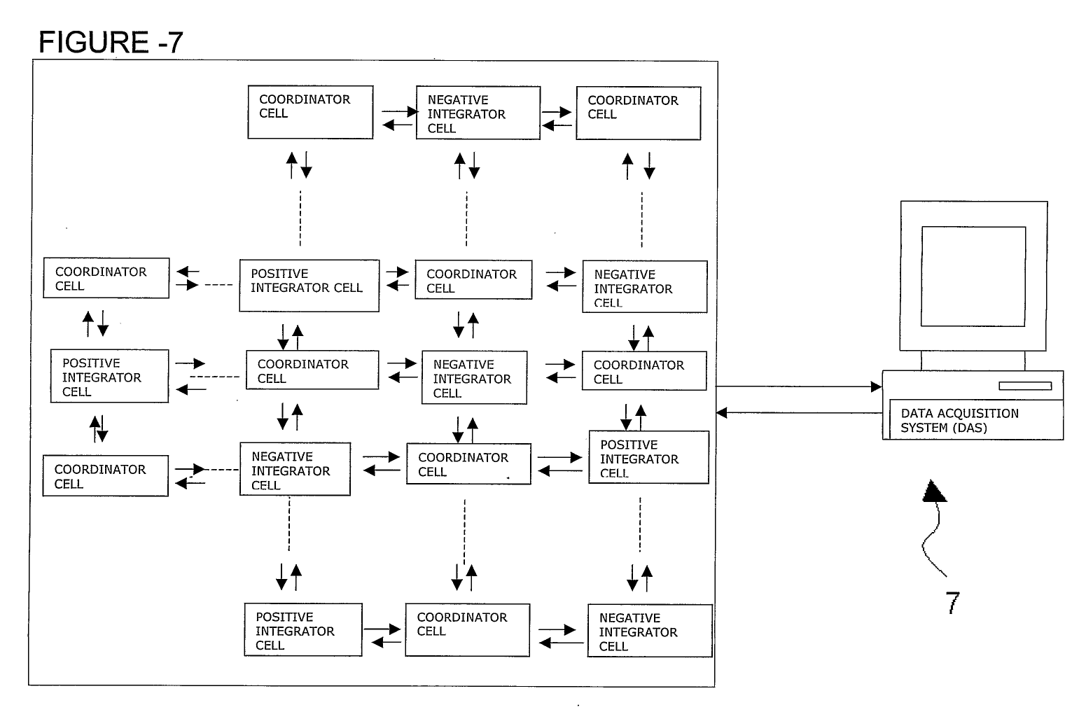

FIG. 7—Block Diagram of the Hybrid Computer of the Present Invention.

The numerals and their definitions in the figures are as follows:
1. Negative integrating circuit with analog memory.
2. Positive integrating circuit with analog memory.
3. Negative integrating circuit with digital memory.
4. Positive integrating circuit with digital memory.
5. Follower circuit.
6. Coordinator circuit.

7. Digital computer.

| | | | | |
|---|---|---|---|---|
| 101. Switch-1 | 201. Node-1 | 301. Opamp-1 | 401. R₁ | 501. Capacitor-1 |
| 102. Switch-2 | 202. Node-2 | 302. Opamp-2 | 402. R₂ | 502. Capacitor-2 |
| 103. Switch-3 | 203. Node-3 | 303. Opamp-3 | 403. R₃ | 503. Capacitor-3 |
| 104. Switch-4 | 204. Node-4 | 304. Opamp-4 | 404. R(τ) | |
| 105. Switch-5 | 205. Node-5 | 305. Opamp-5 | 405. R₅ | |
| 106. Switch-6 | 206. Node-6 | 306. Opamp-6 | 406. R₆ | |
| 107. Switch-7 | 207. Node-7 | 307. Opamp-7 | 407. R₇ | |
| 108. Switch-8 | 208. Node-8 | 308. Opamp-8 | 408. R₈ | |
| 109. Switch-9 | 209. Node-9 | | 409. R₉ | |
| 110. Switch-10 | 210. Node-10 | | 410. R₁₀ | |
| 111. Switch-11 | 211. Node-11 | | 411. R₁₁ | |
| 112. Switch-12 | 212. Node-12 | | 412. R₁₂ | |
| | 213. Node-13 | | 413. R₁₃ | |
| | 214. Node-14 | | 414. R₁₄ | |
| | 215. Node-15 | | 415. R₁₅ | |
| | 216. Node-16 | | 416. R₁₆ | |
| | | | 417. R₁₇ | |
| | | | 418. R₁₈ | |
| | | | 419. R₁₉ | |
| | | | 420. R₂₀ | |

Hybrid computer of the invention, includes a positive integrator cell comprising at least one positive integrator circuit (2), a negative integrator cell comprising at least one negative integrator circuit (1), a coordinator cell that provides the connection of these cells with each other; including a coordinator circuit (6) together with a negative or positive integrator circuit (1, 2), and a digital computer having a data acquisition system (DAS) (7) that stores data from micro controllers and analog integrators.

The quantity of the cells for the hybrid computer of the invention and the quantity of the circuits for these cells can be at desired number. Cells also comprise digital micro controllers. A/D and D/A converters on the micro controllers provide the data exchange between the analog circuits of the cells and micro controllers.

In the hybrid computer of the invention, integrator cells are connected to each other through coordinator cells and can work in simultaneous and continuous manner. Furthermore, the quantity of the analog integrator circuit of the positive and negative integrator cells can be increased if it is desired. Said hybrid computer operates at two main modes.
I. Reset Mode
II. Run Mode

The switches of the integrator circuits in the cells perform switching between above-mentioned modes. In the hybrid computer of the invention, initial conditions are loaded to the integrator circuits at the reset mode before starting to the integration. Initial conditions are loaded to the Capacitor-2 (502) on the analog circuits of the positive and negative integrator cells through Node-3 (203) when the hybrid computer is in the reset mode and before integration. The Switch-12 (112) providing a connection between the node-3 (203) and the capacitor-2 (502) is in an open position when the hybrid computer of the invention is in run mode.

The drift voltage, which may occur as the operational amplifiers (Opams) are used as integrators, is stored in the memory of the hybrid computer during the reset mode, while this magnified drift voltage is used to compensate for the error during the run mode. Operations such as summation, subtraction, multiplication or division by a constant number and integration are applied either time continuously or as continuous digital updating to the time variable information coming to the coordinator cell from the neighboring positive and negative cells and processed feedback information flow is provided from the coordinator cells to the neighboring integrator cells. By means of micro controllers comprised in the cell and the data acquisition system of the digital computer (DAS), information exchange between the computer and the analog circuits is achieved, information transferred to the digital computer are processed and results displayed. The hybrid computer is brought to the rest mode in convenient time intervals. In the reset mode all analog integrators (1, 2) of the hybrid computer are isolated from the system. This way, the drift (error) voltages that may have changed in time due to changes in physical conditions, such as temperatures, are recorded as new error values and for the next run mode these newly updated values are used error cancellation. During the short isolation period, if suitable capacitors are used, the capacitor voltages of the positive and negative integrator cells (1, 2) as well as the analog memory of the coordinators (6) follower (5) circuits do not change and the system is only frozen. If desired, before the analog circuits are set to reset mode, the integrator values may be recorded in digital memory of the micro controllers and transferred back as the run mode resumes.

While the hybrid computer is in the reset mode and the analog circuits contained in the cells are isolated from each other, the micro controller part of the cells continue to correspond with the digital computer (7) that processes and store the acquired information coming from the cells. When the hybrid computer of the invention resume the run mode, all integrator cells are interconnected via coordinator cells and integration process continues from the point it has stopped. In the run mode all cells work simultaneously and time continuously, data obtained from the analog circuits are transferred to the digital circuitry via A/D (analog to digital) converters of the micro controllers. In a similar way, data coming from the digital circuits are transferred to the analog circuits via D/A (digital to analog) converters of the micro controllers. Further more, micro controllers of the hybrid computer of the invention are programmable ones.

When the hybrid computer is in the reset mode:

Since the integrator input voltage changes its sign during integration, non-inverting input of the negative integrator circuit (1), namely Opamp-1 (input Opamp) (301) is grounded at Node-4 (204) through Switch-1 (101). Resistor R₁ (401) connected to the Opamp-1 (301) output and the inverting input through the Switch-5 (105) is connected to Node-4 (204) through the resistor R₂ (402). The output of Opamp-1 (301) is connected to the inverting input of the Opamp-2 (302) by the Switch-2 (102) through the resistor R₃ (403). Furthermore, there is a resistor connected to the output of Opamp-2 (302) and inverting input and the value of this resistor R₃ (403) is equal to the value of the resistor. The output of Opamp-2 (302) is connected to the Capacitor-1 (501) by means of the Switch-3 (103) at the closed position. This end of Capacitor-1 (501) is also connected to the non-inverting input of Opamp-3 (303). However, when the negative integrator circuit (1) is in the reset mode, Opamp-3 (303) is disabled by means of the Switch-5 (105), which is open in the reset mode.

When the negative integrator circuit with analog memory is in reset mode (FIG. 1a), the value of the input voltage is zero since the non-inverting (+) input of Opamp-1 (301) is grounded. However error voltage occurring at the output, reaches to inverting (−) input of Opamp-2 (302) by magnifying as much as possible according to the type of the Opamp used with the proportion of the value of resistor R₁ (401) to the value of resistor R₂ (402) and it is obtained as multiplied with (−1) at the output of Opamp-2 (302). This value is loaded to the Capacitor-1 (501). Therefore, Capacitor-1 (501) constitutes the “magnified error” analog memory unit of negative integrator circuits (1). However, it is also possible to use digital memory instead of the analog one. In the case of using digital memory in negative integrator circuit, when the hybrid computer of the invention is in reset mode, drift voltage value occurred at the output of Opamp-1 (301) is loaded to the digital memory by means of A/D converters at Node-15 (215) through Switch-2 (102). In the case of using digital memory in the negative integrator circuit Capacitor-1 (501), Opamp-2 (302) and Opamp-3 (303) are not used in the circuit.

Analog integrator circuit of positive integrator cell (2) is similar in structure to negative integrator circuit (1) with a small difference. This difference appears when the hybrid computer is in the run mode. When the positive integrator circuit (2) having analog memory is in the reset mode (FIG. 2a), the Switch-6 (106) at the input of the circuit is open and hence positive integrator circuit (2) is isolated from other circuits. As mentioned above for the negative integrator circuit (1), error voltage is loaded to the Capacitor-1 (501) composing the analog memory unit. Digital memory can be used for loading process instead of analog memory. When digital memory is used in the positive integrator circuit (4), Capacitor-1 (501), Opamp-3 (303) and Switch-6 (106) is removed from the structure of the circuit and the output of Opamp-1 (301) is connected to the digital memory at Node-15 (215) through the Switch-2 (102). When the hybrid computer of the invention is in reset mode, error voltage value occurring at the output of Opamp-1 (301) is loaded to this digital memory (FIG. 5a). A/D converters are used for loading.

In the hybrid computer of the invention, coordinator cell providing a connection between the positive and negative integrator cells comprises of two circuits which are symmetric to each other and a coordinator circuit (6) consisting of follower circuits (5) and a positive (2) or a negative integrator circuit (1) connected to it. Coordinator input resistors R₅ and R₆ (405, 406) connected to the output of neighboring positive and negative integrator cells are connected to the inverting input of Opamp-5 (305), input resistors R₇ and R₈ (407, 408) are connected to the non-inverting input of Opamp-5 (305). Input resistor R₅ (405) is connected to the resistor R₉ (409) at Node-10 (210), the other leg of the resistor R₉ (409) is connected to the output of Opamp-5 (305) at Node-11 (211). The output voltage of the Opamp-5 (305) is fed back via the resistor R₉ (409) to inverting input of this Opamp (305). The input resistor R₈ (408) is connected to the resistor R₁₀ (410) at Node-9 (209) and the other end of the resistor R₁₀ is grounded. The output of Opamp-5 (305) is connected to a follower circuit (5) at Node-11 (211). The output of follower circuit (5) is connected to R(τ) (404). There are input resistors in the other symmetrical part of the coordinator circuit (6) also connected to the output of neighboring positive and negative integrator cells. From these, the resistors R₁₁ and R₁₂ (411, 412) are connected to inverting input of Opamp-6 (306), the resistors R₁₃ and R₁₄ (413, 414) are connected to non-inverting (+) input of Opamp-6 (306). As mentioned above, in this part of the coordinator the output of Opamp connected to the input resistors is connected to a follower circuit (5). Two circuits of symmetrical structure composing the coordinator circuit (6) combine at Node-14 (214), from where a connection to the input (201) of a positive or negative integrator circuit (1,2) of the coordinator cell is provided.

When the hybrid computer is in reset mode, positive and negative integrator circuits (1,2) are separated from the coordinator circuit (6) and hence they are separated from each other, as well as the follower circuits (5) of the coordinator are separated from the coordinator (6).

When the hybrid computer is in reset mode, the high accuracy providing follower circuit (5) contained by the coordinator circuit (6) is grounded via the non-inverting input of Opamp-7 (307) that is connected to Node-12 (212) through Switch-7 (107). Therefore, follower circuit (3) is separated from the coordinator during the reset mode. The resistor R₁₇ (417) connected to the output and the inverting input of Opamp-7 (307). R₁₇ (417) is also connected to the resistor R₁₈ (418) at Node-13 (213). The resistor R₁₈ (418) is connected to Node-12 (212) by means of Switch-9 (109). The error voltage occurring at the output of Opamp-7 (307) with magnifying by the extent of the ratio (R₁₇/R₁₈) for the value of the resistor R₁₇ (417) to the value of the resistor R₁₈ (418) is loaded to Capacitor-3 (503) connected to the non-inverting input of Opamp-8 (308) by passing through the closed Switch-10 (110) and the resistor R₁₉ (419). The Capacitor-3 (503) whose one end is connected to non-inverting input of Opamp-7 (307) composes the analog memory that the error voltage is stored. When the follower circuit (5) operates in the reset mode (FIG. 4a) since the Switch-11 (111) connected to the output of Opamp-8 (308) is open, Opamp-8 (308) is not in the circuit.

When the hybrid computer is in the run mode:

In the negative integrator circuit (1) with analog memory (FIG. 1b), the input voltage which is a function of time, is applied to the input resistor R(τ) (404) (integrator time constant [τ]=C(τ)R(τ)) through Node-1 (201) is applied to the inverting input of Opamp-1 (301). The number of input resistor may be increased, depending on the place the integrator circuit is used. During the application of input voltages, when the circuit is in reset mode, the error voltage loaded to Capacitor-1 (501) is applied to the output of resistors (401, 402) through Opamp-3 (303) and to non-inverting input of Opamp-1 (301) through Node-7 (207). As a result of this, the error voltage reaches Opamp-1 (301) demagnified by an amount of magnification applied in the reset mode. This way, a voltage with opposite sign but equal to the error voltage that was loaded while the input voltage was set to zero is applied to the non-inverting input of Opamp-1 (301) and virtual earth is obtained at the inverting input of Opamp-1 (301) and the reference point of Capacitor-2 (502). Integration done with error correction is transferred to other circuitry time continuously through Opamp-4 (304) (follower Opamp) and Node-2 (202). The output values obtained from Node-2 (202) are the results of integration of the input values with opposite sign. When the negative integrator circuit (1) is in run mode, the output of Opamp-1 (301) is connected to both Capacitor-2 (502) and Opamp-4 (304) through Node-9 (209) by means of the position of Switch-2 (102).

In case of using digital memory in the negative integrator circuit (3) when the hybrid computer is in run mode (FIG. 4b), error voltage at the digital memory is applied to negative integrator circuit (1) from Node-16 (216) by means of D/A converter after it is multiplied by minus one (−1) digitally at this time Node-16 (216) is connected to the output of the resistor R₁ (401) through Switch-5 (105). The method used to minimize the error is as mentioned for negative integrator circuit (1) with analog memory.

A positive input voltage in the negative integrator circuit (1) causes voltage decrease and a negative input voltage causes a voltage increase, in Capacitor-2 (502).

When the negative integrator circuit (1) should be connected to coordinator circuit (6) of the coordinator cell the resistor R (τ) (404) of negative integrator circuit is removed, because the resistor R (τ) (404) already exist in the structure of the coordinator circuit (6).

When the positive integrator circuit (2) is in run mode (FIG. 2b), Switch-6 (106) is closed. Input voltage, which is a function of time, applied to the integrator circuit from Node-1 (201), first reaches the inverting input of Opamp-2 (302) and appears with a sign change at the output of Opamp-2 (302). While the input voltage reaching the input resistor R₄ (τ) (404) through the Switch-3 (103) at the output of Opamp-2 (302) is integrated over Opamp-1 (301), the magnified error voltage loaded to the capacitor-1 (501) during the reset mode firstly reaches the output of the magnification resistors (401, 402) and from there the non-inverting input of Opamp-1 (301) through Node-7 (207). This way, a voltage equal to the error voltage but with an opposite sign is applied to the non-inverting input of Opamp-1 (301) and as a result of this, at the reference leg of the Capacitor-2 (502) virtual earth is obtained through Node-8 (208).

When the positive integrator circuit (2) is in run mode (FIG. 2b), the input voltage which is a function of time, applied to Node-1 (201) firstly changes its sign at Opamp-2 (302) and then it is integrated over R₄(τ) (404) and Opamp-1 (301). Therefore, for the positive input values, positive output values are obtained at the output of Opamp-4 (304), Node-2 (202). The number of input resistor may be increased, depending on the place the integrator circuit is used.

One leg of the Capacitor-1 (501) at the positive and negative circuits (1,2) and non-inverting input of Opamp-2 (302) are grounded at Node-6 (206) permanently. The input leg of Capacitor-2 (502) is grounded through Switch-4 (104) and Node-5 (205) only in the reset mode. As in the case of using analog memory in the positive integrator circuit, a voltage equal to the error voltage but opposite in sign is applied to the non-inverting input of Opamp-1 (301), as a result of this, at the reference leg of the Capacitor-2 (502) virtual earth is obtained through Node-8 (208). A positive input voltage in the positive integrator circuit (2) causes voltage increase and a negative input voltage causes a voltage decrease, in Capacitor-2 (502).

In case of using digital memory in positive integrator circuit (4) in the run mode (FIG. 5b) error voltage at the memory reaches from Node-16 (216) to the output of the resistor R₁ (401) through the D/A converter. Meanwhile, since the Switch-6 (106) is closed, the input voltage applied from Node-1 (201) reaches to the inverting input of Opamp-2 (302) and then its sign is changed and is applied to R (τ) (404)

In case of connecting positive integrator circuit (2) to the coordinator circuit (6) of the coordinator cell, since the coordinator circuit (6) has the resistor R (τ) (404), the resistor R(τ) (404) of positive integrator is removed.

When the hybrid computer of the invention is in run mode, information from the output of neighboring positive and negative cells reach to Opamp-5 (305) in the coordinator circuit (6) through the input resistors R₅, R₆, R₇ and R₈ (405, 406, 407 and 408) and the results of the operations such as summation, addition and multiplication by a constant emerge at the output of Opamp-5 (305). This value emerging at the output of Opamp-5 (305), Node-11 (211) is applied to the non-inverting input of the Opamp-7 (307) over the resistance R₂₀. At this time, the error voltage loaded to Capacitor-3 (503) in the follower circuit (3) during reset mode emerges at the output of Opamp-8 (308) and reaches to the output of the resistor R₁₇ (417) through the Switch-8 (108). The error voltage is demagnified by the ratio of the resistor R₁₇ (417) value to the resistor R₁₈ (418) value is applied to the inverting input of Opamp-7 (307) as a correction voltage. Since the reference leg of Capacitor-3 (503) is connected to the non-inverting input of Opamp-7 (307), the correction voltage applied the to inverting input is affected by the changes in the input voltage and it enables to obtain error-free output voltages for every value of the input voltage. Simultaneously, information from neighboring positive and negative integrator circuits arriving through the input resistors R₁₁, R₁₂, R₁₃ and R₁₄ (411, 412, 413 and 414) of the second part of the coordinator circuit (6) having a symmetrical structure, are applied to Opamp-6 (306) and the output voltage of Opamp-6 (306) is applied to another follower circuit (5) having the same structure as the follower circuit (5) mentioned before. Information emerging at the output of the follower circuits (5) reach Node-1 (201) through the resistors R (τ) (404) and hence to the negative or positive integrator circuit connected to coordinator circuit (6). This way, values coming from the neighboring integrator cells enter the coordinator (6) through the input resistors where they are subjected to some operations such as addition, subtraction, multiplication by a constant and similar are then transferred to other neighboring integrator cells through the positive or negative integrator circuit (1,2) of the coordinator cell. The number of resistors of the coordinator cell (6) can be changed according to the operation desired.

Follower circuits (5) of the coordinator (6) are not shown in detail in FIG. 6 for simplicity and can be seen in detail in FIG. 3a and FIG. 3b.

When the hybrid computer is in run mode, the follower circuit (5) of the coordinator circuit (6); the non-inverting input of Opamp-7 (307) is connected to the resistor R₂₀ (420) through Switch-7 (107) and the output of Opamp-7 (307) is connected to the resistor R₁₈ (418) through the Switch-8 (108) and Switch-9 (109). At this time Switch-10 (110) is open and hence the output of Opamp-7 (307) is disconnected from Capacitor-3 (503). However in the run mode one leg of Capacitor-3 (503) is also connected to non-inverting input of Opamp-7 (307) as in the reset mode. When the follower circuit (5) operates in run mode, the output of Opamp-7 (307) and the resistor R₁₇ (417) is disconnected by means of the Switch-8 (108). The resistor R₁₇ (417) is connected to the output of Opamp-8 (308) by means of the closed Switch-11 (111). When the hybrid computer is in run mode the output voltage values of Opamps (305, 306) of the coordinator circuit (6) reach to their interconnected follower circuit (5) through at least one input resistor (420).). Since the reference leg of capacitor (503) of the follower circuit (5) is connected to non-inverting input of Opamp-1 (301) correction voltage applied to inverting input is affected by the changes in the input voltage. As a result of this, output voltage is kept equal to the input voltage within a few microvolts. The follower circuit providing high accuracy can be located to required places for this purpose.

Firstly, initial conditions are loaded to the integrator cells of the hybrid computer of the invention, during that, integrator cells are in the reset mode and load error voltage. The value of error voltage (drift voltage) is loaded to analog or digital memories of analog integrators magnified by 3 to 4 orders of magnitude. Then integrator circuits (1, 2) are set to run mode, perform the operation with a negligible error, connected to each other through the coordinator circuit (6). Integrator circuits (1,2) use the error voltage loaded to their memories as the correction voltage during integration (In the ±10 V interval error is at μV level). Then the data are transferred to digital computer comprising data acquisition system by means of micro controllers, digital computer processes these data and displays the results.

1. A hybrid computer comprising at least one cell having at least one integrator circuit (1) in which time dependent input voltage is applied through at least one input resistance and its sign is changed after the integration, at least one cell having at least one analog integrator circuit (2) in which the input voltage is applied to the inverting input of Opamp (302) to change sign, then applied to at least one resistor, at least one cell having at least one coordinator circuit (6) and at least one analog integrator circuit connected to said coordinator circuit (6), a micro controller and a digital computer (7) including a data acquisition system, said hybrid computer characterized in that;
i. Analog integrator circuits (1,2) interconnected over coordinator circuits(6) that perform synchronized and time continuous integration.
ii. Disconnection of all analog integrators from each other at required time intervals, loading of the magnified error voltage that occurs when the input voltage of the Opamp's is set to zero, in the memory included in the integrator circuits (1,2).
iii. As the analog integrator circuits (1,2) are interconnected again, demagnifying the error voltages that are loaded in the memories, by the same ratio of magnification applied during loading and use it to eliminate error during integration.
iv. Data transferring from analog circuits to digital computer (7) at desired intervals and displaying the results after processing.

2. The coordinator circuit (6) of claim 1 executing operations such as summation, subtraction of variable voltages, multiplication by a constant, division by a constant and integration having output voltages as feedback to other analog integrator circuits through the analog integrator circuit connected to said coordinator circuit (6).

3. An analog integrator circuit according to claim 1 wherein an operation amplifier (Opamp) (301) having an inverting and a non-inverting input, that provides an output voltage that is fed back via a resistor (401) to said inverting input, when the said non-inverting input is grounded, output voltage (error voltage) of the said amplifier is applied by magnifying to inverting input of another Opamp also having a non-inverting input through a resistor (403), the output voltage of this Opamp is fed back via another resistor having a same resistance to said inverting input, the output voltage of said opamp is loaded to a capacitor (501).

4. An analog integrator circuit (1) according to claim 3 wherein input voltage is a function of time is applied to the inverting input of Opamp (301) through at least one input resistor R(τ) (404) when non-inverting input of said Opamp (301) is not grounded, output of said Opamp (301) is connected to a Capacitor (502) and in turn said Capacitor (502) is connected to input resistor R(τ) (404), the voltage loaded to a Capacitor (501) when non-inverting input of said Opamp (301) is grounded by magnified is applied to non-inverting input of Opamp (301) through a resistor (401) by means of a switch (105) by demagnifying by the amount magnified and the results of integration are transferred to a coordinator circuit (6).

5. An analog integrator circuit (2) according to claim 3 wherein input voltage as a function of time is applied to the inverting input of Opamp (302) also having a non-inverting input through a resistor (403), output voltage of said opamp is fed back via another resistor (403) having same resistance with said resistor (403) to said inverting input of said opamp (302), output voltage of said Opamp with opposite sign is applied to inverting input of another Opamp (301) having an inverting and a non-inverting input through at least one input resistor R(τ) (404), the output of said Opamp (301) is connected to a capacitor (502) and in turn said capacitor (502) is connected to input resistor (404), voltage loaded to the capacitor (501) when non-inverting input of said Opamp (301) is grounded by being magnified is applied by demagnifying to non-inverting input of Opamp (301) through a resistor (401) by means of a switch when non-inverting input of said Opamp (301) is not grounded and the results of integration are transferred to a coordinator circuit (6).

6. A hybrid computer of claim 1 comprising a circuit wherein output voltage of Opamp (307) having an inverting and a non-inverting input is fed back via a resistor (417) to said inverting input of said Opamp when non-inverting input of said Opamp (307) is grounded, output voltage of said Opamp (307) is loaded to a capacitor (503) by being magnified and reference leg of said capacitor (503) is connected to non-inverting input of said Opamp (307).

7. A circuit (5) according to claim 6 wherein input voltage as a function of time is applied to non-inverting input of Opamp (307) having an inverting and a non-inverting input through at least one resistor (420), voltage loaded to a capacitor (503) before by being magnified is applied to inverting input of said Opamp (307) by demagnification with same ratio.

8. A computer according to claim 1 wherein error voltage is loaded to analog memory.

9. A computer according to claim 1 wherein error voltage is loaded to digital memory.

10. A circuit according to claim 3 wherein initial conditions are loaded to the capacitor (502) connected to the input resistor (404).

11. A circuit according to claim 5 wherein initial conditions are loaded to the capacitor (502) connected to the input resistor (404).

12. A computer according to claim 1 wherein results of integration are transferred time continuously to a digital computer (7)

13. A computer according to claim 12 wherein results of integration are transferred continuously to a digital computer (7) by at least one micro controller.

14. A computer according to claim 1 comprising at least one programmable micro controller.
